(19) United States
(12) Patent Application Publication
(10) Pub. No.: US 2026/0291654 A1
(43) Pub. Date: Sep. 24, 2026

(54) TRANSMISSION METHOD AND OMAMRC SYSTEM WITH A SELECTION STRATEGY DURING RETRANSMISSIONS TAKING INTO ACCOUNT THE THROUGHPUT OF THE SOURCES AND OF A SINGLE CONTROL EXCHANGE

(71) Applicant: Orange, Issy-les-Moulineaux (FR)

(72) Inventors: Ali Al Khansa, Chatillon (FR); Raphael Visoz, Chatillon (FR)

(21) Appl. No.: 18/877,231

(22) PCT Filed: Jun. 23, 2023
(86) PCT No.: PCT/EP2023/067145

§ 371 Date: Dec. 19, 2024

(30) Foreign Application Priority Data
Jun. 28, 2022 (FR) 2206443

(51) Int. Cl. H04L 1/1812; H04L 5/16

(52) U.S. Cl. CPC H04L 1/1819; H04L 5/16

(57) ABSTRACT

A method is described for transmitting a frame carrying messages for an OMAMRC telecommunication system having N nodes, including M sources sᵢi∈{1, . . . , M} and a destination, where N≥M≥2. The transmission comprises a maximum number of M+Tmax time intervals per transmitted frame, distributed between a first phase and a second phase. The selection of the sources to be assisted during the second phase takes into account the estimated numbers of retransmission intervals sufficient for the destination to decode the sources not yet correctly decoded and a sum of throughputs assigned to the sources.

### FIELD OF THE INVENTION

The present invention relates to the field of digital communications. Within this field, the invention more specifically relates to the transmission of coded data between at least two sources and a destination with relaying by at least one node that can be a relay or a source.

It is understood that a relay does not have a message to transmit. A relay is a node intended for relaying messages from sources, while a source has its own message to be transmitted and in some cases can also relay the messages of other sources, i.e., the source is referred to as cooperative in this case.

Numerous relaying techniques exist, namely: “amplify and forward”, “decode and forward”, “compress-and-forward”, “non-orthogonal amplify and forward”, “dynamic decode and forward”, etc.

The invention notably, but not exclusively, applies to the transmission of data via mobile networks, for example, for real-time applications, or via arrays of sensors, for example.

Such an array of sensors is a multi-user array, made up of several sources, several relays and a recipient using an orthogonal time multiple access scheme, called Orthogonal Multiple-Access Multiple-Relay Channel (OMAMRC), for the transmission channel between the relays and the sources.

### PRIOR ART

The considered OMAMRC telecommunication system illustrated in FIG. 1 has N nodes and a destination involving implementation of an orthogonal time multiple access scheme for the transmission channel that is applied between the N nodes. The N nodes comprise M sources and L relays. The maximum number of time-slots per transmitted frame is M+Tₘₐₓ, with M slots being allocated during a first phase to the successive transmission of the M sources and T_{used}≤Tₘₐₓ slots for one or more cooperative transmissions being allocated during a second phase to one or more nodes selected by the destination in accordance with a selection strategy. Such an OMAMRC transmission system implementing a selection strategy during the second phase is known from the article by S. Cerović, R. Visoz, and L. Madier entitled, “Efficient Cooperative HARQ for Multi-Source Multi-Relay Wireless Networks”, 14^{th} International Conference on Wireless and Mobile Computing, Networking and Communications (WiMob), IEEE, 2018. The OMAMRC transmission system that is described is such that each of the sources can operate at different instants, either exclusively as a source, or as a relay node. Node terminology equally covers a relay and a source acting as a relay node or as a source. A relay differs from a source since it has no message to transmit that is specific thereto, i.e., it merely retransmits messages originating from other nodes.

The links between the various nodes of the system are subject to slow fading and Gaussian white noise. For the destination, knowledge of all the links of the system (CST: Channel State Information) is not available. Indeed, the links between the sources, between the relays, between the relays and the sources cannot be directly observed by the destination and for them to be known by the destination would require an excessive exchange of information between the sources, the relays and the destination. In order to limit the cost of the feedback overhead, shown as dotted lines in FIG. 1, only one item of information concerning the distribution/statistic of the channels (CDI: Channel Distribution Information) of all the links, for example, average quality (for example, average SNR, average SINR) of all the links, is assumed to be known by the destination for the purpose of determining the throughputs allocated to the sources.

The link adaptation is said to be of the slow type, i.e., before any transmission is carried out, the destination allocates initial throughputs to the sources knowing the distribution of all the channels (CDI: Channel Distribution Information). In general, it is possible to feed back to the CDI distribution based on the knowledge of the average SNR or SINR of each link of the system.

The transmissions of the messages from the sources are formatted into frames, during which the CSIs of the links are assumed to be constant (slow fading hypothesis). It is assumed that the throughput allocation does not change over several hundred frames, it only changes with the changes in CDI.

The method distinguishes three phases: an initial phase and, for each frame to be transmitted, a first phase and a second phase. A frame is transmitted over two phases, which are optionally preceded by an additional phase, called initial phase.

During the initialization phase, the destination determines an initial throughput Rᵢ for each source sᵢ taking into account the average quality (for example, SNR) of each of the links of the system. The destination estimates the quality (for example, SNR) of the direct links: source to destination and relay to destination, in accordance with known techniques based on the exploitation of reference signals. The quality of the source-source, relay-relay and source-relay links is estimated by the sources and the relays by exploiting the reference signals, for example. The sources and the relays transmit the average qualities of the links to the destination. This transmission occurs before the initialization phase. With only the average value of the quality of a link being taken into account, its refresh rate occurs over a long time scale, i.e., over a time that allows the fast fading of the channel to be averaged. This time is of the order of the time required to travel several tens of wavelengths of the frequency of the transmitted signal for a given speed of a node of the system. The initialization phase occurs every 200 to 1,000 frames, for example. The destination feeds back the initial throughputs that it has determined to the sources via a feedback path. The initial throughputs remain constant between two occurrences of the initialization phase.

During the first phase, the M sources successively transmit their message during the M time-slots respectively using modulation and coding schemes determined from the initial throughputs. During this phase, the number N₁ of channel uses (i.e., resource element according to 3GPP terminology) is fixed and identical for each source.

During the first phase, the independent sources together broadcast their sequences of coded information in the form of messages for the attention of a single recipient. Each source broadcasts its messages with its initial throughput. The destination sends each source its initial throughput via control channels with a very limited throughput. Thus, during the first phase, the sources each transmit their respective message in turn during time-slots that are each dedicated to a source.

The sources other than that which transmits, and optionally the relays, of the “Half-Duplex” type, receive the successive messages from the sources and decode them.

During the second phase, the destination selects a single node for the current slot t that is taken from among the sources and the relays in order to cooperate. This node randomly selects the source that it assists from among the source that it has correctly decoded and that the destination has not yet correctly decoded by transmitting a redundancy for the message from this source. This phase lasts for a maximum Tₘₐₓ of time-slots. During this phase, the number N₂ of channel uses is fixed and identical for each of the selected nodes (sources and relays).

This article provides teaching on control signals, which for the destination involves broadcasting M bits that indicate its set of sources correctly decoded for the slot t−1, for the nodes that have correctly decoded a source that the destination has not yet correctly decoded to transmit a signal over a dedicated unicast channel and for the others to remain silent and, finally, for the destination to broadcast the result of its selection in accordance with the selected selection strategy. Although these exchanges limit the overhead associated with the signaling while maximizing the average spectral efficiency (utility metric) within the considered system subject to complying with an individual quality of service (QoS) per source, it can be desirable to further limit the signaling overhead.

The present invention addresses this objective.

### MAIN FEATURES OF THE INVENTION

The subject matter of the present invention is a method for transmitting a frame carrying messages intended for an OMAMRC telecommunication system having M sources sᵢ i∈{1, . . . , M}, optionally L relays r₁, . . . , r_{L} and a destination, M≥2, L≥0, with the nodes operating in half-duplex mode, in accordance with an orthogonal multiple access scheme of the transmission channel between the N nodes with a maximum number of M+Tₘₐₓ time-slots per transmitted frame distributed between a first phase and a second phase, 1≤Tₘₐₓ, with the message of a source having been coded before transmission in accordance with an incremental redundancy type coding that generates several redundancies, the first phase comprises M slots respectively allocated to the successive transmissions of the M sources and the second phase comprises at least one retransmission slot for a transmission of nodes that has correctly decoded the same source sᵢ, such that these nodes simultaneously transmit, during the same retransmission slot, the same redundancy of the message from the same source not yet correctly decoded by the destination, called source to be assisted. The method according to the invention is such that it comprises:
a single transmission by the nodes of at least their set of sources correctly decoded and not yet correctly decoded by the destination, with these transmissions allowing the destination to determine, for each of these sources, a quality of an equivalent channel based on a quality of the channels between the nodes that have correctly decoded this source and the destination;
estimating a sufficient number of retransmission slots (xᵢ(0)) so that the destination decodes a source (sᵢ) not yet correctly decoded and correctly decoded by at least one node based on the quality of an equivalent channel for this source between this at least one node and the destination and a throughput (Rᵢ) assigned to this source (sᵢ);
the destination selecting the sources to be assisted by taking into account the estimated numbers (xᵢ(0)) of retransmission slots sufficient for the destination to decode the sources not yet correctly decoded and a sum of throughputs (Rᵢ) assigned to the sources.

Thus, the number of exchanges of control between the source and the nodes is reduced to a single exchange, during which the nodes send the destination their set of correctly decoded sources. If the destination has previously sent its own set of correctly decoded sources, the transmission by the nodes may only contain their set of correctly decoded sources less those already correctly decoded by the destination. The transmission of the nodes allows the destination to assess the quality of the node-destination channels in order to estimate a sufficient number of retransmission slots per source so that the destination correctly decodes this source. Knowing these sufficient numbers of slots, the destination can then successively select, either randomly, or in an ordered manner, the sources to be assisted from among those whose sufficient number of slots is less than the time remaining before reaching Tₘₐₓ. The ordering can be carried out by successively selecting the sources as a function of the increasing sufficient numbers of slots. The invention has the advantage of not wasting a transmission if no source can be assisted within the remaining time.

A further aim of the invention is a system comprising M sources s₁, . . . , s_{M}, optionally L relays r₁, . . . , r_{L} and a destination d, M≥2, L≥0, for implementing a transmission method according to the invention.

According to one embodiment of the invention, the single transmission by the nodes of at least their set of sources correctly decoded and not yet correctly decoded by the destination is carried out at the beginning of the second phase.

According to one embodiment of the invention, the method further comprises a comparison between a sum of estimated numbers of retransmission slots that are sufficient to assist the destination to decode sources not yet correctly decoded and a number of remaining time slots during the second phase to assist the destination to correctly decode one or more sources.

According to this embodiment, the method adds at least two estimated sufficient numbers of retransmission slots and compares the result with the remaining time. If the result of the addition is less than the remaining time, all the sources involved in the addition can be assisted during the second phase.

According to one embodiment of the invention, the comparison is updated after the destination correctly decodes a source.

Since the correct decoding of a source by the destination can occur before the end of the estimated number sufficient of retransmission slots (cooperative transmissions), this embodiment allows another source to help benefit from the unconsumed time.

According to one embodiment of the invention, the single transmission by the nodes of at least their set of sources correctly decoded and not yet correctly decoded by the destination forms part of an exchange of control, during which the source transmits its set of correctly decoded sources.

According to one embodiment of the invention, the method is such that, during the exchange, a node only sends its set of sources correctly decoded and not yet correctly decoded by the destination.

According to one embodiment of the invention, the method is such that, during the exchange, a node sends its set of correctly decoded sources.

According to one embodiment of the invention, the method further comprises a comparison between the estimated numbers of retransmission slots sufficient for the selection to take into account an order for these sufficient estimated numbers of retransmission slots. According to this embodiment, the estimated sufficient numbers of retransmission slots are classified according to their value. Furthermore, preferably, the method initially selects the source for which the estimated sufficient number of retransmission slots is the smallest. The same source is assisted over the duration corresponding to this estimated number or over a shorter duration if its correct decoding by the destination occurs before the end of the estimated number. The method thus successively considers the remaining sources to be correctly decoded. The method is stopped when all the sources are correctly decoded by the destination, when no source not yet correctly decoded can be assisted or when the maximum time is reached.

According to one embodiment of the invention, the method further comprises determining a set of sources that can be assisted taking into account sufficient estimated numbers of retransmission slots and a remaining time before the end of the second phase and such that the selection of the sources to be assisted occurs randomly from among all the sources that can be assisted.

According to one embodiment of the invention, the method is such that if no source can be assisted within the time remaining before the end of the second phase, then the transmission of the frame is interrupted before using the sufficient maximum number of retransmission slots. A further aim of the invention is each of the specific software applications on one or more information media, with said applications comprising program instructions adapted for implementing the transmission method when these applications are executed by processors. A further aim of the invention is configured memories comprising instruction codes respectively corresponding to each of the specific applications.

The memory can be incorporated in any entity or device capable of storing the program. The memory can be of the ROM type, for example, a CD-ROM or a microelectronic circuit ROM, or even of the magnetic type, for example, a USB key or a hard disk.

Moreover, each specific application according to the invention can be downloaded from a server accessible on a network of the Internet type.

The optional features described above within the context of the transmission method optionally can be applied to the software application and to the aforementioned memory.

### LIST OF FIGURES

Further features and advantages of the invention will become more clearly apparent upon reading the following description of embodiments, which are provided by way of simple illustrative and non-limiting examples, and with reference to the appended drawings, in which:

FIG. 1 is a diagram of an example of a system, called Cooperative OMAMRC (Orthogonal Multiple Access Multiple Relays Channel) system described with reference to the prior art;

FIG. 2 is a diagram of a transmission cycle of a frame according to one embodiment of the invention;

FIG. 3 is a diagram of the protocol of the exchanges of decoding control between the destination and the nodes, sources and relays, according to one embodiment of the invention.

### DESCRIPTION OF PARTICULAR EMBODIMENTS

A channel use is the smallest granularity in terms of time-frequency resource defined by the system that allows a modulated symbol to be transmitted. The number of channel uses is linked to the available frequency band and to the transmission duration.

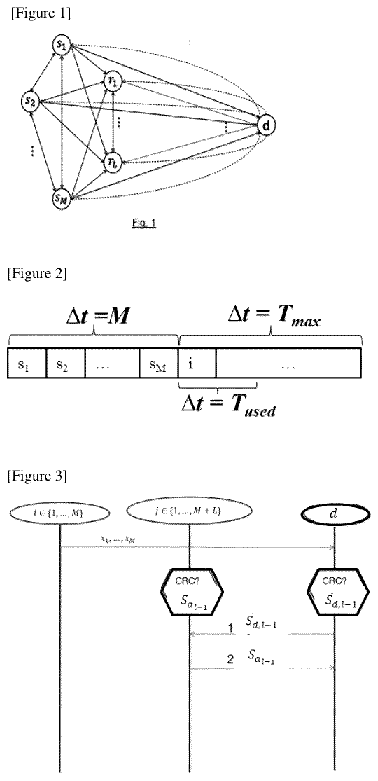

An OMAMRC system is illustrated in FIG. 1, already described.

An OMAMRC system according to the invention comprises M sources that belong to the set of sources [symbol] ={s₁, . . . , s_{M}}, optionally L relays that belong to the set of relays [symbol] ={r₁, . . . r_{L}} and a destination d. By convention, it is considered that sᵢ=i∀i∈{1, . . . , M} and rᵢ=M+i∀i∈{1, . . . , L}, in other words, a source and its index can be merged, as can a relay and its index (offset from the value M of the number of sources). Each source of the set [symbol] communicates with the single destination with the assistance of the other sources (user cooperation) and of the relays that cooperate.

### Transmission Cycle of a Frame According to the Invention

A transmission cycle of a frame according to one embodiment of the invention is illustrated in FIG. 2.

The method according to the invention distinguishes two phases for each frame to be transmitted, namely, a first phase and a second phase. The transmission of a frame is optionally preceded by an additional phase, called initial phase, during which the throughputs are allocated.

The M sources access the transmission channel according to an orthogonal time multiple access scheme during the first phase. During the second phase, access to the transmission channel by the N nodes that comprise the M sources and optionally the L relays is considered to be orthogonal, since for each retransmission slot the active nodes transmit the same redundancy of the same message from the same source i at the same time.

The N nodes operate in a half-duplex mode that allows them to listen to the transmissions of the other nodes without any interference. The sources can behave like a relay when they do not only transmit their own message.

The CSIs of the links are assumed to be constant (slow fading hypothesis) when transmitting a frame. From time to time, the destination allocates throughputs to the sources knowing the distribution of all the channels (CDI: Channel Distribution Information).

It is assumed that the allocation of throughputs does not change over several hundred frames, it only changes with any changes in the CDI.

Each of the allocated throughputs unambiguously determines a Modulation and Coding Scheme (MCS) and, conversely, each MCS determines a throughput. The allocated throughputs are fed back from the destination to the sources via control channels with a very limited throughput (shown as dotted lines in FIG. 1).

For the sake of simplifying the description, the following assumptions are subsequently made concerning the OMAMRC system:
the sources, the relays and the destination are equipped with a single transmission antenna (or transmission antenna port);
the sources, the relays and the destination are equipped with a single reception antenna (or reception antenna port);
the sources, the relays and the destination are perfectly synchronized;
the sources are statistically independent (there is no correlation between them);
all the nodes transmit with the same power;
a CRC code is used that is assumed to be included in the Kᵢ information bits of each source i in order to determine whether or not the message associated with the information bits is correctly decoded, i∈ [symbol] ;
the links between the various nodes experience additive noise and fading. The fading gains are set when transmitting a frame over a maximum duration of M+Tₘₐₓ time-slots, but can change independently from one frame to another. Tₘₐₓ≥1 is a parameter of the system;
the instantaneous quality of a direct channel/link on reception (CSIR (Channel State Information at Receiver)) is available to the destination, to the sources and to the relays;
all feedback is error-free (no error in the control signals/channels).

The following notations are used:
Rᵢ=Kᵢ/N₁ is a discrete variable representing the throughput of the source i provided by a link adaptation method implemented before the frames are transmitted;
T_{used} is the number of retransmission slots used during the second phase, T_{used}∈{1, . . . , Tₘₐₓ}, it corresponds to the number of transmissions during this phase;
α=N₂/N₁ is the ratio between the number of channel uses available for each time-slot of the second phase and the number of channel uses available for each time-slot of the first phase;
S̅_{d,l} a is the set of sources not correctly decoded by the destination at the end of the retransmission slot l, l∈{1, . . . , T_{used}};
Sₐ_{ₗ} is the set of sources correctly decoded by the node a∈ [symbol] ∪ [symbol] at the end of the retransmission slot l, l∈{1, . . . , T_{used}};
O_{i,t} is the fault indicator (outage) that assumes the value of one when an individual fault event occurs and assumes the value of zero in the other cases O_{i,T}_{ₘₐₓ} represents the fault event of the source i, i.e., the source is not correctly decoded after sending a frame given that the maximum number of retransmission slots Tₘₐₓ has been reached without this source i being correctly decoded. The individual fault event O_{i,t} depends, for each retransmission slot t (slot), on the mutual information of the nodes that have correctly decoded the source i;
I_{i,d} represents the mutual information between the source i∈{1, . . . , M} and the destination d;
J_{i,d}(l) represents the mutual information between the set of nodes assisting the source i and the destination on the retransmission slot 1 (it is considered to be an equivalent channel formed by the various channels between these nodes and the destination). By convention J_{i,d}(0) is equal to I_{i,d}.

### Transmission of a Frame According to the Invention

During the first phase of the method, the sources i∈ [symbol] successively transmit their message uᵢ after coding, with said message comprising Kᵢ information bit

$${u}_{i} ∈ {𝔽}_{2}^{{K}_{i}} ,$$

with [symbol] ₂ being the two-element Galois body. The message uᵢ comprises a code of the CRC type that allows the integrity of the message uᵢ to be verified. The message uᵢ is coded according to the MCS determined by the allocated throughput. Given that the MCSs can differ between the sources, the lengths of the coded messages can differ between the sources. The coding uses an incremental redundancy type code. The code word that is obtained is divided into successive redundancies. The incremental redundancy code can be of the systematic type, the information bits are then included in the first redundancy. Whether or not the incremental redundancy code is of the systematic type, it is such that the first redundancy can be decoded independently of the other redundancies. The incremental redundancy type code can be produced, for example, by means of a finite family of punctured linear codes with compatible rates or of codes with no rate modified to operate with finite lengths: raptor code (RC). RCPTC rate compatible punctured turbo code, RCPCC rate compatible punctured convolutional code, rate compatible LDPC (RCLDPC rate compatible low density parity check code).

The transmission by a source conventionally comprises one or more reference signals. In a known manner, the destination estimates the channel and therefore its quality between each source and the destination by exploiting the one or more received reference signals, for example.

Whether during the first phase or the second phase, when a node transmits, in particular a source, the destination and the other nodes listen.

The destination, the sources and the relays attempt to decode the received redundancies at the end of a time-slot. The decoding success on each node is decided by using the CRC. The destination and the nodes thus determine their set of sources correctly decoded for each slot. The second transmission phase of the method comprises t={1, . . . , T_{used}} retransmission slots with the convention that t=0 corresponds to the last transmission slot of the first phase. The term retransmission associated with a slot is used in connection with the second phase in order to clearly indicate that any transmission during this phase of an n^{th} redundancy of the message from a source i occurs while this source i has already transmitted the 1^{st} redundancy of this same message during the first phase.

Unlike the prior art, for each retransmission slot there is no exchange of decoding control between the destination and the nodes: for each retransmission slot the destination does not systematically feed back its set of correctly decoded sources or an indication as to whether or not a decoding is correct, for each retransmission slot the nodes do not systematically transmit their set of correctly decoded sources or any indication as to whether or not their decoding is correct. The exchange of decoding control for updating whether the destination is aware of the sets of sources correctly decoded by the nodes only occurs when t=1, i.e., at the beginning of the second phase. This exchange can equivalently occur at the end of the first phase.

During this exchange, the nodes send the destination their set of correctly decoded sources or at least their set of sources correctly decoded and not yet correctly decoded by the destination. The transmission by a node conventionally comprises one or more reference signals. In a known manner, the destination estimates the channel and therefore its quality between each node and the destination by exploiting the one or more reference signals received for this slot t=1, for example.

Thus, the nodes send the destination their set of correctly decoded sources or at least their set of sources correctly decoded and not yet correctly decoded by the destination once only, i.e., during the last transmission slot, t=0, or, equivalently, during the first retransmission slot, t=1.

However, the destination selects, for each retransmission slot, a source, called source to be assisted, using a broadcast control channel from the destination to the nodes. The nodes that have correctly decoded this source then transmit the same redundancy of the message from this source during this slot by using a data channel. Assisting a source means helping the destination to decode this source, which involves the nodes that have correctly decoded this source transmitting a redundancy of the message of this source during the second phase.

### Selection According to the Invention

The selection, by the destination, of a source to be assisted for each retransmission slot is explained hereafter with reference to FIG. 3, which illustrates the single exchange of decoding control between the destination and the nodes according to one embodiment. According to this embodiment, the destination feeds back its set of correctly decoded sources to the nodes and the nodes transmit their set of correctly decoded sources. According to another embodiment, the destination feeds back its set of correctly decoded sources to the nodes and the nodes transmit their set of sources correctly decoded and not yet correctly decoded by the destination. According to another embodiment, the destination feeds back a signal, NACK, to the nodes that indicates a lack of correct decoding, and the nodes transmit their set of correctly decoded sources.

During the second phase, the destination in turn orders the sources not yet correctly decoded for a given number of successive transmissions in order to maximize the received throughput sum. A transmission, during a retransmission slot, to assist a source i corresponds to the transmission of the same redundancy version of its message by all the nodes that have correctly decoded this source. The transmissions to assist a source i begin on the retransmission slot t_{s,i}, and end when the source is decoded.

The individual fault event of the source i, for which the retransmission slots begin at t_{s,i}, at the end of the retransmission slot t−1, O_{i,t-1}, can be expressed in the following format:

$${O}_{i , t - 1} = \{ {R}_{i} > {I}_{i , d} + α {\sum }_{l = {t}_{s , i}}^{t - 1} {J}_{i , d} ( l ) \} \qquad ( 1 )$$

This expression reflects the fact that the source i is not correctly decoded on the retransmission slot t−1 if the throughput Rᵢ of the source is greater than the sum of the transmission capacities. This transmission capacity comprises the capacity of the channel between this source i and the destination that occurs during the first phase and a sum weighted by α of the capacities of the equivalent channels that occur during the second phase from t_{s,i} up to the retransmission slot t−1. On the retransmission slot l≥t_{s,i} of the second phase, an equivalent channel is considered for the source i. The equivalent channel considered for a retransmission slot l groups the channels between each of the nodes assisting the source i during this slot and the destination. The capacity of the channel between this source i and the destination is deduced from the quality of the channel, i.e., the mutual information I_{i,d} between the source i∈{1, . . . , M} and the destination d. The capacity of the considered equivalent channel when the source i is assisted during the slot l is assessed by the mutual information J_{i,d}(l) between the set of nodes that assist the source i on the retransmission slot l and the destination. This capacity depends on the time l, since a node can benefit from transmissions in order to assist a source i during the second phase and to correctly decode this source i from a retransmission slot of the second phase, while it had not decoded it at the end of the first phase.

X(t) is defined as the number of retransmission slots that has elapsed up until the current slot (not inclusive), during the second phase since the last exchange of decoding control between the destination and the nodes.

X^{m}(t) defines the value of X(t) that triggers a new exchange of sets of decoded sources. For example, X^{m}(t)=2∀t∈{1, . . . , Tₘₐₓ} triggers an exchange of sets of decoded sources for tⱼ=1+2j with

$$j ∈ \{ 1 , ... , ⌊ \frac{( {T}_{max} - 1 )}{2} ⌋ \} .$$

By convention, X^{m}(1)=0 triggers an exchange of sets of decoded sources at the beginning of the second transmission phase.

It is assumed that a source i is assisted over one or more consecutive retransmission slots, starting with the retransmission slot t_{s,i}∈{1, . . . , Tₘₐₓ}. For each retransmission slot (time-slot) t≥t_{s,i}, and for the selected source i not yet correctly decoded by the destination i∈S̅_{d,t-1}, the variable \hat{x}ᵢ(t) is defined according to the invention. This variable \hat{x}ᵢ(t) is defined as being the maximum number (i.e., sufficient number) of retransmission slots in order for the destination to decode this source i (from and counting the retransmission slot tₛ), i.e., at the latest the source i is decoded at the end of the retransmission slot t+\hat{x}ᵢ(t)−1. This variable \hat{x}ᵢ(t) is estimated by the destination as a function of its knowledge of J_{i,d}(l)∈{t_{s,i}, . . . t}. Let the set S′={t′₀, t′₁, . . . , t′_{N}} determined by X^{m}(t) for retransmission slots beginning with an exchange of sets of decoded sources. Let the set S={t₀, t₁, . . . , t_{M}} for retransmission slots beginning with an exchange of sets of decoded sources coinciding with the transmissions to assist the source i, i.e., t_{s,i}<t₀≤t₁≤ . . . ≤t_{M}.

In the event that an exchange of sets of decoded sources has occurred before t_{s,i}, i.e., before the beginning of the selection of the source i to be assisted during the second phase, the destination knows Ĵ_{i,d}(t_{s,i})=J_{i,d}(t_{s,i})=J_{i,d}(1). It should be emphasized that an exchange of sets of decoded sources at the beginning of the second transmission phase allows the destination to know J_{i,d}(t_{s,i}) for all the sources. Indeed, with the transmissions preceding t_{s,i} being linked to another source, they do not affect the number of nodes that have decoded the source i, nor J_{i,d}(t_{s,i}) for all i∈{1, . . . , M}.

Otherwise, the destination only knows Ĵ_{i,d}(t_{s,i})=J_{i,d}(0)=I_{i,d} for estimating \hat{x}ᵢ(t) for t_{s,i}≤t<t₀. For the sake of simplifying the notations, the source index i of t_{s,i} is omitted when it is obvious.

For the retransmission slots tₛ≤t<t₀, the invention considers:

$${y}_{i} ( {t}_{s} ) = \frac{{R}_{i} - {I}_{i , d}}{α {\hat{J}}_{i , d} ( {t}_{s} )} \qquad ( 2 )$$

$$and$$

$${y}_{i} ( t ) = \frac{{y}_{i} ( {t}_{s} ) ( α {\hat{J}}_{i , d} ( {t}_{s} ) ) - α ( t - {t}_{s} ) {\hat{J}}_{i , d} ( {t}_{s} )}{α {\hat{J}}_{i , d} ( {t}_{s} )} , \qquad ( 3 )$$

the sufficient number of retransmission slots estimated by the destination from the retransmission slot t is:

$${\hat{x}}_{i} ( t ) = ⌈ {y}_{i} ( t ) ⌉ \qquad ( 4 )$$

where ┌q┐ represents the upper integer part function (ceiling function) that assumes the integer value that is just greater than or equal to q, for example, ┌2.3┐=3.

For t=t₀, an exchange of sets of decoded sources occurs, which allows the destination to evaluate J_{i,d}(t₀), thus:

$${y}_{i} ( {t}_{0} ) = \frac{{y}_{i} ( {t}_{s} ) ( α {\hat{J}}_{i , d} ( {t}_{s} ) ) - α ( {t}_{0} - {t}_{s} ) {\hat{J}}_{i , d} ( {t}_{s} )}{α {J}_{i , d} ( {t}_{0} )} \qquad ( 5 )$$

$$with$$

$${\hat{x}}_{i} ( {t}_{0} ) = ⌈ {y}_{i} ( {t}_{0} ) ⌉ \qquad ( 6 )$$

More generally, for tⱼ<t≤tⱼ₊₁ j=0, . . . , M−1, it is possible to recursively construct yᵢ(t) as:

$${y}_{i} ( t ) = \{ \begin{matrix}\frac{\begin{matrix}{y}_{i} ( t - X ( t ) ) ( α {J}_{i , d} ( t - X ( t ) ) ) - \\ α X ( t ) {J}_{i , d} ( t - X ( t ) )\end{matrix}}{α {J}_{i , d} ( t - X ( t ) )} & {t}_{j} < t < {t}_{j + 1} \\ \frac{\begin{matrix}{y}_{i} ( t - X ( t ) ) ( α {J}_{i , d} ( t - X ( t ) ) ) - \\ α X ( t ) {J}_{i , d} ( t - X ( t ) )\end{matrix}}{α {J}_{i , d} ( t )} & t = {t}_{j + 1}\end{matrix} \qquad ( 7 )$$

or, equivalently:

$${y}_{i} ( t ) = \{ \begin{matrix}\frac{{y}_{i} ( {t}_{j} ) ( α {J}_{i , d} ( {t}_{j} ) ) - α ( t - {t}_{j} ) {J}_{i , d} ( {t}_{j} )}{α {J}_{i , d} ( {t}_{j} )} & {t}_{j} < t < {t}_{j + 1} \\ \frac{{y}_{i} ( {t}_{j} ) ( α {J}_{i , d} ( {t}_{j} ) ) - α ( {t}_{j + 1} - {t}_{j} ) {J}_{i , d} ( {t}_{j} )}{α {J}_{i , d} ( {t}_{j + 1} )} & t = {t}_{j + 1}\end{matrix} \qquad ( 8 )$$

still with:

$${\hat{x}}_{i} ( t ) = ⌈ {y}_{i} ( t ) ⌉ .$$

Please note:

$$\begin{matrix}{\hat{x}}_{i} ( t ) = ⌈ \frac{{y}_{i} ( {t}_{j} ) ( α {J}_{i , d} ( {t}_{j} ) ) - α ( t - {t}_{j} ) {J}_{i , d} ( {t}_{j} )}{α {J}_{i , d} ( {t}_{j} )} ⌉ = {\hat{x}}_{i} ( {t}_{j} ) - ( t - {t}_{j} ) & {t}_{j} < t < {t}_{j + 1}\end{matrix} \qquad ( 9 )$$

Between two exchanges of decoding control, the sufficient number of retransmission slots for decoding the source i is decremented upon each transmission assisting the source i.

For t>t_{M}, it becomes:

$${\hat{x}}_{i} ( t ) = ⌈ \frac{{y}_{i} ( {t}_{M} ) ( α {J}_{i , d} ( {t}_{M} ) ) - α ( t - {t}_{M} ) {J}_{i , d} ( {t}_{M} )}{α {J}_{i , d} ( {t}_{M} )} ⌉ \qquad ( 10 )$$

Finally, in the event that no exchange of sets of decoded sources is carried out either before or after tₛ, it becomes:

$${\hat{x}}_{i} ( t ) = ⌈ \frac{{R}_{i} - {I}_{i , d} - α ( t - {t}_{s} ) {J}_{i , d} ( 0 )}{α {J}_{i , d} ( 0 )} ⌉ ∀ t \geq {t}_{s} \qquad ( 11 )$$

In the event that a single exchange of sets of decoded sources is carried out at the beginning of the second transmission phase, then:

$${\hat{x}}_{i} ( t ) = ⌈ \frac{{R}_{i} - {J}_{i , d} - α ( t - {t}_{s} ) {J}_{i , d} ( 1 )}{α {J}_{i , d} ( 1 )} ⌉ ∀ t \geq {t}_{s} \qquad ( 12 )$$

\hat{x}ᵢ(t) is the number of retransmission slots to assist the source i from the retransmission slot t included as sufficient for error-free decoding of the source i that is estimated by the destination as a function of its knowledge of J_{i,d}(l)∀l∈{t_{s,i}, . . . , t+\hat{x}ᵢ(t)−1}. The destination uses, as an approximation of J_{i,d}(l), a previous (closest known) value Ĵ_{i,d}(l)=J_{i,d}(l′) with l′≤l, consequently, Ĵ_{i,d}(l)≤J_{i,d}(l)∀l∈{t_{s,i}, . . . , t+\hat{x}ᵢ(t)−1}.

The number of retransmission slots that is necessary in practice xᵢ^{a}(t) requires knowledge of

$${J}_{i , d} ( l ) ∀ l ∈ \{ {t}_{s , i} , … , t + {x}_{i}^{a} ( t ) - 1 \} .$$

It is provided by the smallest value of x, such that:

$${R}_{i} \leq {I}_{i , d} + α {\sum }_{l = {t}_{s , i}}^{t + x - 1} {J}_{i , d} ( l ) \qquad ( 13 )$$

The estimate \hat{x}ᵢ(t) is the smallest value of x, such that:

$${R}_{i} \leq {I}_{i , d} + α {\sum }_{l = {t}_{s , i}}^{t + x - 1} {\hat{J}}_{i , d} ( l ) \qquad ( 14 )$$

As Ĵ_{i,d}(l)≤J_{i,d}(l), it simply becomes \hat{x}ᵢ(t)≥xᵢ^{a}(t).

In the event that Ĵ_{i,d}(l)=J_{i,d}(1), it becomes:

$${\hat{x}}_{i} ( t ) = ⌈ \frac{{R}_{i} - α ( t - {t}_{s , i} ) {J}_{i , d} ( 1 )}{α {J}_{i , d} ( 1 )} ⌉ \qquad ( 15 )$$

Indeed, the smallest positive integer is such that:

$$x \geq \frac{{R}_{i} - {I}_{i , d} - α {J}_{i , d} ( 1 ) ( t - {t}_{s , i} )}{α {J}_{i , d} ( 1 )} \qquad ( 16 )$$

$$\text{is:}$$

$${\hat{x}}_{i} ( t ) = ⌈ \frac{{R}_{i} - α ( t - {t}_{s , i} ) {J}_{i , d} ( 1 )}{α {J}_{i , d} ( 1 )} ⌉ \qquad ( 17 )$$

Thus, it is certain that the fault event (outage) does not occur at t+\hat{x}ᵢ(t)−1. The source i is systematically correctly decoded by the destination at t+\hat{x}ᵢ(t)−1 if it is assisted \hat{x}ᵢ(t) times from the slot t inclusive.

The generalization of this demonstration in the case of several exchanges of decoding is immediate.

It should be noted that the assessment of the sufficient number of retransmission slots for a source i is the same irrespective of whether t_{s,i} is its retransmission slot selected for the first transmission intended to assist this source during the second phase. For a given retransmission slot t, \hat{x}ᵢ(t) only depends on the number of transmissions nᵢ=t−t_{s,i} assisting the source i during the second phase and before t. Thus, the notation xᵢ(nᵢ) denotes the necessary number of transmissions assisting the source i knowing the number of transmissions nᵢ that assisted the source i (already carried out) during the second phase. Hereafter, xᵢ denotes the counter of the number of remaining transmissions for assisting the source i, with this counter being set to xᵢ(0) and being decremented each time the source i is assisted without an exchange of decoding. This counter is updated for each exchange of decoding control for the retransmission slot l=tⱼ j=0, . . . , M−1, which allows J_{i,d}(l) to be known.

If the estimate of xᵢ is such that there has been no previous transmission to assist the source i or such that xᵢ(0) solely relies on the knowledge of the direct links and that for all the sources i∈{1, . . . , M}, the following inequality is met:

$${T}_{m ax} \geq {\sum }_{i ∈ {\overline{S}}_{d , t - 1}} {x}_{i} \qquad ( 18 )$$

then all the sources can be decoded without exchanging sets of decoded sources.

With all the sources being able to be correctly decoded by the destination over the remaining time, the method randomly successively selects, for example, the sources to be assisted.

The method according to the invention is particularly advantageous when Tₘₐₓ<Σ_{i∈S̅}_{_{d,t-1}}xᵢ, since it allows the destination to correctly decode an optimal number of sources by optimizing the spectral efficiency, while significantly limiting the signaling overhead by selecting the source to be assisted according to a certain strategy.

In addition, according to the invention X^{m}(1)=0, i.e., the exchange of control of sets of sources correctly decoded between the destination and the nodes only occurs once and at the beginning of the second phase.

At t=1, i.e., at the beginning of the second phase, the method includes an exchange of decoding control between the destination and the nodes. The method determines the sufficient number of retransmission slots so that the destination decodes the source i not yet decoded at the end of the first phase knowing its assigned throughput Rᵢd:

$${\hat{x}}_{i} ( t ) = ⌈ \frac{{R}_{i} - {I}_{i , d} - α ( t - {t}_{s , i} ) {\hat{J}}_{i , d} ( {t}_{s , i} )}{α {\hat{J}}_{i , d} ( {t}_{s , i} )} ⌉ ∀ t \geq {t}_{s} \qquad ( 19 )$$

$$with :$$

$${\hat{x}}_{i} ( {t}_{s , i} ) = {x}_{i} ( 0 ) = ⌈ \frac{{R}_{i} - {I}_{i , d}}{α {\hat{J}}_{i , d} ( {t}_{s , i} )} ⌉ \qquad ( 20 )$$

or, even with nᵢ=t−t_{s,i},

$${\hat{x}}_{i} ( t ) = {x}_{i} ( {n}_{i} ) = ⌈ \frac{{R}_{i} - {I}_{i , d} - α {n}_{i} {\hat{J}}_{i , d} ( {t}_{s , i} )}{α {\hat{J}}_{i , d} ( {t}_{s , i} )} ⌉ = {x}_{i} ( 0 ) - {n}_{i} \qquad ( 21 )$$

with nᵢ being the number of transmissions already carried out to assist the source i. Following the exchange of decoding control between the destination and the nodes for t=1, the destination knows Ĵ_{i,d}(t_{s,i})=J_{i,d}(t_{s,i})=J_{i,d}(1). Without an exchange of decoding control for t=1, the destination is based on Ĵ_{i,d}(t_{s,i})=J_{i,d}(0)=I_{i,d}, i.e., on knowledge of the direct link between the source i and the destination.

The estimate of the channel between the source i and the destination is carried out, for example, based on the reference signals transmitted by the source i when it transmits during the first phase. Since the channels are assumed to be invariant during a frame, this value is independent of the transmission or retransmission slot. This knowledge of the quality of the channel between the source i and the destination allows the destination to estimate mutual information I_{i,d} representing this quality and therefore the capacity of the channel.

During the second phase, the estimate of the channel between the node j∈{1, . . . , M+L} and the destination is carried out, for example, based on a reference signal transmitted by the node j during the exchange of control during which it transmits its set or a subset of this set of correctly decoded sources. This knowledge of the quality of the channel between the node j and the destination for the slot t=1 allows the destination to estimate mutual information J_{i,d}(1) representing the quality of the equivalent channel between all the nodes that decoded the source i and the destination.

For t>1 the method considers that each transmission leads to mutual information αJ_{i,d}(1), such that \hat{x}ᵢ(t) decreases as a function of the number of transmissions carried out to assist the source i.

According to the invention, the destination selects the source i to be assisted for each retransmission slot t.

For each retransmission slot t, and before selection, the remaining number of retransmission slots Tₐᵥ is: Tₐᵥ=Tₘₐₓ−T_{used}. A t=0, T_{used}=0.

The selection is determined in order to maximize the spectral efficiency. The maximization of the spectral efficiency can be expressed in the form of the determination of the subset Â taken from the set P(S̅_{d,t-1}) of possible subsets A of sources not yet correctly decoded by the destination for the slot preceding the current slot t leading to the largest sum of the throughputs of the sources and such that the sources of this subset Â can be decoded over the remaining time, Tₐᵥ, i.e., such that the remaining time is greater than or equal to the sum of the sufficient number of retransmission slots for decoding each of the sources of this subset Â:

$$\hat{A} = arg {max}_{A ∈ P ( {\overline{S}}_{d , t - 1} )} \times {\sum }_{i ∈ A} {R}_{i} , such that {\sum }_{i ∈ A} {x}_{i} \leq {T}_{av} \qquad ( 22 )$$

P(S̅_{d,t-1}) is called the power set of S̅_{d,t-1}.

The method then successively considers each source i of this subset Â.

For each considered source i of Â, the destination sends the nodes the indication of the selection of the source i for the retransmission slot t.

The nodes that have correctly decoded this source i transmit the same redundancy during this slot t in order to assist the decoding of the source i by the destination.

The destination reiterates the transmission of the indication of the selection of the same source i until the destination correctly decodes this source. The number of retransmission slots elapsed before correct decoding is at most equal to xᵢ(0).

According to a particularly effective embodiment, if the destination correctly decodes the source i before the number xᵢ(0) of retransmission slots has elapsed, it re-computes the best subset Â if and only if the set Â from which the source i is drawn does not contain all the sources not decoded by the destination, otherwise the destination transitions to another source of the subset Â from which the source i has been previously drawn. This case can occur when the set of sources correctly decoded by a node changes to include the source i during xᵢ(0) retransmission slots. Thus, this node becomes active during the transmission, for the slot l, of a redundancy for the source i, which increases the mutual information J_{i,d}(l)>J_{i,d}(1). If the source i is decoded after exactly xᵢ(0) retransmission slots, then the destination transitions to another source of the subset Â from which the source i has been previously drawn.

### EMBODIMENT

The following description of an embodiment of the invention is illustrated with an implementation by an OMARC system having M=4 sources, S={1,2,3,4}, L=3 relays, R={5,6,7}, and a destination. The parameter Tₘₐₓ is set to 8.

At the end of the first phase, i.e., t=0, the sets of sources correctly decoded by the nodes are as follows:

$${S}_{1 , 0} = \{ 1 \} , {S}_{2 , 0} = \{ 2 \} , {S}_{3 , 0} = \{ 3 \} , {S}_{4 , 0} = \{ 4 \} , \\ {S}_{5 , 0} = \{ 2 , 3 \} , {S}_{6 , 0} = \{ 1 , 2 , 3 \} , {S}_{7 , 0} = ϕ , {S}_{d , 0} = ϕ .$$

In other words, the sources 1, 2, 3, 4 and the relay 7 have not yet correctly decoded anything at the end of the first phase, but as a source knows its own message, its set contains at least this message. The relay 5 has correctly decoded the sources 2 and 3 and the relay 6 has correctly decoded the sources 1, 2 and 3 at the end of the first phase. The destination d has not yet correctly decoded anything and S̅_{d,0}≠φ at the end of the first phase.

During the second phase, the step involving the destination determining the set of sources Â to be assisted proceeds, for example, according to the algorithm in Appendix A.

During the second phase, the selection of the source i to be assisted from among the set Â for each retransmission slot proceeds, for example, according to the algorithm in Appendix B, which can be used since S̅_{d,}≠φ.

Sequence for the Algorithm of Appendix B:

Step 2. The destination determines the estimate of the number of necessary slots xᵢ so that the destination decodes a source i not yet decoded based on knowledge of mutual information of the destination source link i and of a throughput Rᵢ assigned to this source i. The destination therefore computes xᵢ for all i∈S̅_{d,0}.

For this example, the variables xᵢ have the following values knowing the direct source-destination links:

$${x}_{1} = 6 , {x}_{2} = 2 , {x}_{3} = 3 , {x}_{4} = 12.$$

The throughputs Rᵢ have the following values:

$${R}_{1} = 1 , {R}_{2} = 2 , {R}_{3} = 3 , {R}_{4} = 4 .$$

Step 3. The sum of the xᵢ exceeds the remaining time: 6+2+3+12=23>Tₐᵥ=Tₘₐₓ=8.

Step 4. A single exchange of decoding control occurs between the destination and the nodes.

During this exchange, the nodes transmit their set of correctly decoded sources or only their set of sources correctly decoded but not yet correctly decoded by the destination.

Step 5. For a source i not yet decoded by the destination, the destination updates the estimate of the xᵢ by using the quality of the equivalent channel considered to be the aggregation of the channels between the nodes that have correctly decoded this source and the destination.

According to the example, knowing the node-destination links, the variables xᵢ become:

$${x}_{1} = 6 , {x}_{2} = 1 , {x}_{3} = 3 , {x}_{4} = 12.$$

Although x₂ has decreased, the sum of the xᵢ: 6+1+3+12=22 remains greater than the remaining time Tₐᵥ=Tₘₐₓ=8.

Step 7. The set of sources Â to be assisted at the end of the first phase is determined, according to the algorithm of Appendix A, by the destination knowing the xᵢ and the throughputs Rᵢ assigned to the sources.

According to the example, the possible choices for Â that meet Σ_{i∈A} xᵢ≤Tₐᵥ are: {1}, {2}, {3}, {1,2}, {1, 3}, {2, 3}. The set that leads to the maximum sum of the throughputs and that is determined according to the algorithm of Appendix A is Â={2,3}.

Step 8. The method decodes the frame provided that t<Tₘₐₓ and that there is still a source i to be decoded in the set Â, i.e., Â≈φ.

According to the example, Â={2,3}.

Step 9. For the retransmission slot t, the destination selects the source i with the smallest xᵢ.

According to the example, the destination initially selects the source 2.

Step 10. The method repeats steps 11-20 provided that the source i is not correctly decoded by the destination.

According to the example, the destination repeats for the source 2 until it has correctly decoded it and then repeats for the source 3.

Step 11. For each retransmission slot t, the destination feeds back the number of the source i to be assisted by the nodes.

According to the example, the destination initially feeds back the number 2 provided that it is not correctly decoded and then the number 3 provided that it is not correctly decoded.

Step 12. The method increments the value of the current retransmission slot, t←t+1, decrements the remaining time, Tₐᵥ←Tₐᵥ−1 and decrements the value of xᵢ, since i has been assisted once by the nodes.

According to the example, for the source i=2, for the first passage, xᵢ=0, since x₂=1 and the current slot becomes t=2, and Tₐᵥ=7.

For the source i=3, for the first passage, xᵢ=2, since x₃=3 and the current slot becomes t=3, and Tₐᵥ=6.

For the source i=3, for the second passage, xᵢ=1 and the current slot becomes t=4 and Tₐᵥ=5.

Step 13. If the destination has correctly decoded the source i for the current slot, then proceed with steps 14-18.

According to the example, the source i=2 is correctly decoded in a single retransmission slot since x₂=1. S_{d,1}={2}.

For the source i=3, the method returns to step 11 after a retransmission slot.

S_{d,2}={2}. After a second retransmission slot, the source i=3 is correctly decoded. S_{d,3}={2,3}.

Step 14. The source i correctly decoded by the destination is removed from the set Â.

According to the example, at the beginning of the second retransmission slot, Â=Â\{2}={3}.

At the end of the second retransmission slot, Â is unchanged: Â={3}.

At the end of the third retransmission slot, Â=Â\{3}=Ø.

Step 15. If the xᵢ slots have not been consumed and the set Â did not contain all the sources not correctly decoded by the destination (when determining Â the sum of the xᵢ exceeded the remaining time), then the method proceeds with steps 16-17.

According to the example, for the source i=2, x₂=1−1=0, therefore, the condition xᵢ>0 is not met although the condition Â={3}≠S̅_{d,1}={1,3,4} is fulfilled, the method proceeds to step 19, i.e., the method repeats steps 10-18 for the source i=3.

For the source i=3 it is correctly decoded, according to the example, at the end of two retransmission slots x₃=3−2=1. As xᵢ>0 and Â=Ø≠S̅_{d,4}={1,4}, then the method updates the set Â according to step 16.

Step 16. The method determines the set Â according to the algorithm of Appendix A with the updated set of the sources not correctly decoded by the destination.

According to the example, after correctly decoding the source i=3, the algorithm of Appendix A is used with (5, S̅_{d,4}) to update Â.

According to the algorithm of Appendix A, since Σxᵢ=6+12=18>5 and x₁=6>5 and x₄=12>5, then Â=Ø.

Step 20. The method returns to step 8 with Â updated.

According to the example, Â=Ø, i.e., no other source can be decoded in the remaining time.

The transmission of the frame is interrupted, there is a decoding defect (outage event) for sources 1 and 4. The method transitions to the transmission of the next frame.

According to another embodiment, the selection of a source in step 9 can be carried out randomly from among the sources of the set Â.

### Appendix A

Determining the set Â of the sources that can be assisted:

TABLE 1
Computation of Â#1(Tₐᵥ, S̅_{d})

| | | | |
|---|---|---|---|
| 1. | \| | if (S̅_{d} = φ), then | |
| 2. | \| | Â = φ | If there are no more |
| | \| | | sources to decode then Â |
| | \| | | is the empty set |
| 3. | \| | $otherwise if ( {T}_{a v} > {\sum }_{i}^{M} {x}_{i} {1}_{\{ i ∈ {\overline{S}}_{d} \}} )$ | |
| 4. | \| | Â ← S̅_{d} | If there are enough slots |
| | \| | | (rounds) remaining for |
| | \| | | retransmission then Â |
| | \| | | includes the entire set |
| | \| | | of sources not decoded |
| | \| | | by the destination |
| 5. | \| | otherwise | |
| 6. | \| | $\hat{A} ← arg {max}_{A ∈ P ( {\overline{S}}_{d} )} {\sum }_{i ∈ A} {R}_{i}$ | If not, Â includes the set |
| | \| | such that Σ_{i∈A} xᵢ ≤ Tₐᵥ) | with the sum of the |
| | \| | | highest throughputs and |
| | \| | | meeting the condition of |
| | \| | | the number of remaining |
| | | | retransmission slots |
| 7. | \| | End if | |

### Appendix B

Selection strategy algorithm:

TABLE 2

| | | |
|---|---|---|
| 1. | t ← 0; Tₐᵥ ← Tₘₐₓ | End of the first transmission |
| | | phase, i.e., t is set to 0, |
| | | initialization of the remaining |
| | | number Tₐᵥ of retransmission |
| | | slots at Tₘₐₓ |
| 2. | Compute xᵢ for all i ∈ S̅_{d,0} | xᵢ(0) is estimated based on the |
| | | direct source-destination links at |
| | | the end of the first phase. |
| | t ← 1 | Beginning of the second |
| | | transmission phase, i.e., t is set to 1 |

| 3. | \| \| | $If ( {T}_{a v} < {\sum }_{i}^{M} {x}_{i} {1}_{\{ i ∈ {\overline{S}}_{d , 0} \}} ) , then$ | | | | If not enough retransmission slots (rounds) for decoding all the |
|---|---|---|---|---|---|---|
| | \| | | | | | sources, then |
| 4. | \| | The relay nodes send their set of | | | | the destination requires an |
| | \| | correctly decoded sources, Sₐ_{_{i−1}} | | | | exchange of control |
| 5. | \| | update xᵢ for all i ∈ S̅_{d,1} | | | | xᵢ(0) is estimated based on the |
| | \| | | | | | equivalent node-destination channel |
| 6. | \| | End of if | | | | |
| 7. | | ComputeÂ#1(T_{av,} S̅_{d,1}) | | | | Determining the set Â at the |
| | | | | | | beginning of the second phase |
| | | | | | | according to Appendix A |
| 8. | \| | Provided that (t < Tₘₐₓ and Â ≠ φ), | | | | Frame decoding is stopped at |
| | \| | then | | | | Tₘₐₓ or when Â is the empty set |
| 9. | \| | $Selection of the source i ← arg {min}_{i ∈ \hat{A}} {x}_{i}$ | | | | The destination selects the source i with the smallest xᵢ from the set Â |
| 10. | \| | \| | Provided that (i ∉ S̅_{d,t}), then | | | The destination decodes the |
| | \| | \| | | | | source i provided that it has not |
| | \| | \| | | | | correctly decoded it |
| 11. | \| | \| | The destination requires the relay | | | The relay nodes that have |
| | \| | \| | nodes to assist the source i | | | correctly decoded the source i |
| | \| | \| | | | | transmit the same redundancy at |
| | \| | \| | | | | the same time |
| 12. | \| | \| | t ← t + 1; Tₐᵥ ← Tₐᵥ − 1 ; | | | Incrementation of the current |
| | \| | \| | xᵢ ← xᵢ − 1; | | | round t; decrementation of the |
| | \| | \| | | | | number of remaining rounds; |
| | \| | \| | | | | decrementation of xᵢ since i has |
| | \| | \| | | | | been assisted once |
| 13. | \| | \| | \| | if (i ∈ S_{d,t}), then | | if i is decoded at the end of the |
| | \| | \| | \| | | | round t then |
| 14. | \| | \| | \| | Â ← Â\ {i} | | remove i from Â |
| 15. | \| | \| | \| | \| | if (xᵢ > 0 and Â ≠ S̅_{d,t}), then | If i has been decoded before xᵢ |
| | \| | \| | \| | \| | | has expired and the set A differs |
| | \| | \| | \| | \| | | from the sources not yet decoded |
| | \| | \| | \| | \| | | by the destination, then |
| 16. | \| | \| | \| | \| | ComputeÂ#1(Tₐᵥ, S̅_{d,t}) | re-compute Â with an updated set S̅_{d,t} |

| | | | | | |
|---|---|---|---|---|---|
| 17. | \| | \| | \| | \| | End of if |

| | | | | |
|---|---|---|---|---|
| 18. | \| | \| | \| | End of if |

| | | | |
|---|---|---|---|
| 19. | \| | \| | End of provided that |

| | | |
|---|---|---|
| 20. | \| | End of provided that |

1. A method for transmitting a frame carrying messages intended for an OMAMRC telecommunication system having N nodes, including M sources sᵢ i∈{1, . . . , M} and a destination, N≥M≥2, with the nodes operating in half-duplex mode, in accordance with an orthogonal multiple access scheme of the transmission channel between the N nodes with a maximum number of M+Tₘₐₓ time-slots per transmitted frame distributed between a first phase and a second phase, 1≤Tₘₐₓ, with the message of a source having been coded before transmission in accordance with an incremental redundancy type coding that generates several redundancies, the first phase comprising M slots respectively allocated to the successive transmissions of the M sources and the second phase comprising at least one retransmission slot for a transmission of nodes that has correctly decoded the same source sᵢ, such that these nodes simultaneously transmit, during the same retransmission slot, the same redundancy of the message from the same source not yet correctly decoded by the destination, referred to as the source to be assisted, the method comprising:
a single transmission by the nodes of at least their set of sources correctly decoded and not yet correctly decoded by the destination, with these transmissions allowing the destination to determine, for each of these sources, a quality of an equivalent channel based on a quality of the channels between the nodes that have correctly decoded this source and the destination;
estimating a sufficient number of retransmission slots so that the destination decodes a source (sᵢ) not yet correctly decoded and correctly decoded by at least one node based on the quality of an equivalent channel for this source between this at least one node and the destination and a throughput assigned to this source (sᵢ);
the destination selecting the sources to be assisted by taking into account the estimated sufficient numbers of retransmission slots for the destination to decode the sources not yet correctly decoded and a sum of throughputs assigned to the sources.

2. The method of claim 1, wherein the single transmission by the nodes of at least their set of sources correctly decoded and not yet correctly decoded by the destination is carried out at the beginning of the second phase.

3. The method of claim 1, further comprising a comparison between a sum of estimated numbers of retransmission slots that are sufficient to assist the destination to decode sources not yet correctly decoded and a number of remaining time-slots during the second phase to assist the destination to correctly decode one or more sources.

4. The method of claim 3, wherein the comparison is updated after the destination correctly decodes a source.

5. The method of claim 1, wherein the single transmission by the nodes of at least their set of sources correctly decoded and not yet correctly decoded by the destination forms part of an exchange of control, during which the source transmits its set of correctly decoded sources.

6. The method of claim 5, wherein, during the exchange of control, a node only sends its set of sources correctly decoded and not yet correctly decoded by the destination.

7. The method of claim 5, wherein, during the exchange of control, a node sends its set of correctly decoded sources.

8. The method of claim 1, further comprising a comparison between the estimated sufficient numbers of retransmission slots for the selection to take into account an order for these estimated sufficient numbers of retransmission slots.

9. The method of claim 1, further comprising determining a set of sources that can be assisted taking into account estimated sufficient numbers of retransmission slots and a remaining time before the end of the second phase and such that the selection of the sources to be assisted occurs randomly from among all the sources that can be assisted.

10. The method claim 9, wherein if no source can be assisted within the time remaining before the end of the second phase, then the transmission of the frame is interrupted before using the sufficient maximum number of retransmission slots.

11. A system comprising N nodes including M sources sᵢ i∈{1, . . . , M} and a destination, N≥M≥2, for implementing the transmission method of claim 1.
